(19) United States
(12) Patent Application Publication
(10) Pub. No.: US 2005/0219686 A1
(43) Pub. Date: Oct. 6, 2005

(54) Microscope

(76) Inventors: Kazuhiko Osa, Hachioji-shi (JP); Yasunori Makara, Hino-shi (JP)

Correspondence Address: KENYON & KENYON, 1500 K STREET NW, SUITE 700, WASHINGTON, DC, 20005, US

(21) Appl. No.: 11/085,475

(22) Filed: Mar. 22, 2005

(30) Foreign Application Priority Data
Apr. 1, 2004 (JP) JP 2004-109401

(51) Int. Cl. G02B 21/00

(52) U.S. Cl. 359/368; 359/383

(57) ABSTRACT

A laser scanning-type confocal microscope is provided, which can obtain a clear image at all times without being affected by pulsation or the like of a sample. The laser scanning-type confocal microscope comprises an abutting member at an end of an objective optical system to be arranged close to the sample, which is capable of moving in an optical axis direction and being positioned at a desired position in the optical axis direction with respect to the objective optical system.

### BACKGROUND OF THE INVENTION

1. Field of the Invention

The present invention relates to laser scanning-type confocal microscopes used for fluorescence observation and confocal fluorescence observation, in applications such as the elucidation of cellular functions, and imaging.

2. Description of Related Art

Conventionally, a laser-scanning type confocal microscope is a known apparatus for observing cellular functions or the like, by illuminating a sample of a living body with excitation light from the surface thereof and by selectively detecting fluorescence emitted from a location at a predetermined depth in the sample (see, for example, Japanese Unexamined Patent Application Publication No. HEI 3-87804 (page 2, etc. therein) and Japanese Unexamined Patent Application Publication No. HEI 5-72481 (FIG. 1, etc. therein)).

In addition to standard microscope observation, by scanning the laser light, which is focused to a minute spot region on the sample, using scanning means such as a galvano mirror, this laser-scanning type confocal microscope detects fluorescence emitted from the sample to obtain images.

Since this laser scanning-type confocal microscope can therefore eliminate light other than that from the minute spot being examined due to its excellent resolving power, it has the advantage of being able to obtain detailed examination images with a high signal-to-noise (S/N) ratio.

However, when confocal fluorescence in vivo examination of a sample (rat or a small animal) disposed on a stage is to be carried out by using the conventional laser scanning-type confocal microscope, the distance between the sample and the end of an objective lens system changes due to the pulsation of the sample, thereby causing a problem such as the focal point becoming out of focus or images becoming blurred.

### BRIEF SUMMARY OF THE INVENTION

In light of such problems, it is an object of the present invention to provide a laser scanning-type confocal microscope that can obtain a clear image without being affected by pulsation or the like of the sample.

In order to achieve the above object, the present invention provides the following solutions.

The present invention provides a microscope including an abutting member at an end of an objective optical system to be arranged close to a sample, which is capable of moving in an optical axis direction and being positioned at a desired position in the optical axis direction with respect to the objective optical system.

According to this invention, since the abutting member capable of moving in the optical axis direction and being positioned at a desired position in the optical axis direction with respect to the objective optical system is provided at the end of the objective optical system, by pressing the surface of the examination site of the sample with the end of the abutting member, the influence of pulsation or the like of the sample on the surface of the examination site can be reduced (or eliminated). Moreover, since the distance between the surface of the examination site and the end of the objective optical system (that is, the working distance) can be kept constant at all times, a shift of the working distance can be prevented, thereby obtaining a clear image.

In a preferable aspect of the above invention, the abutting member comprises a cylindrical member arranged outside of an outer cylinder of the objective optical system.

According to this aspect, the abutting member is a hollow cylindrical member, which can be manufactured easily, and hence the production cost can be reduced.

In a preferable aspect of the above invention, a cutter having a blade provided so as to be able to move in an optical axis direction with respect to the outer cylinder of the objective optical system unit and the abutting member, and to protrude from the end of the abutting member, is provided between the outer cylinder of the objective optical system and the abutting member.

According to this aspect, a membrane on the surface of the sample is cut out in a round shape by the cutter having the blade, so that the tissue under the surface can be easily examined. Therefore, the tissue located deep under the surface can be examined by using an inexpensive laser scanning-type confocal microscope having a simple structure, without using an expensive multiphoton excitation type microscope having a complicated structure, at a level as good as the multiphoton excitation type microscope.

In the above aspect, it is preferable that the cutter be provided rotatably about the optical axis of the objective optical system.

According to this configuration, a membrane on the surface of the sample can be cut out in a round shape by pressing the cutter against the surface of the sample and rotating the cutter about the optical axis of the objective optical system.

In a preferable aspect of the above invention, the abutting member is provided with a service port, through which a fluid can be injected to the vicinity of the end of the objective optical system, or the fluid can be sucked from the vicinity of the end of the objective optical system.

According to this aspect, internal secretion on the surface of the sample can be sucked by connecting a suction tube to one end of the service port, and further air and physiological saline solution can be supplied onto the surface of the sample by connecting an air supply tube and a physiological saline solution supply tube to the one end thereof. As a result, the internal secretion can be sucked and removed from the surface of the sample, or the surface of the sample can be washed by the physiological saline solution, and hence, the observation field of view can be kept clean at all times, thereby enabling favorable examination. Moreover, by sucking the inside of the abutting member to hold the abutting member and the sample in an attracted state, more stable examination becomes possible.

In an preferable aspect of the above invention, a cutter is provided at the end of the abutting member.

According to this aspect, since the cutter is provided at the end of the abutting member, by only pressing the end face of the abutting member against the surface of the sample, the membrane on the sample surface can be cut out in a round shape, thereby enabling easy examination of the tissue under the surface. Therefore, the tissue located deep under the surface can be examined by using the inexpensive laser scanning-type confocal microscope having a simple structure, without using the expensive multiphoton excitation type microscope having a complicated structure, at a level as good as the multiphoton excitation type microscope.

According to the present invention, since the abutting member capable of moving in the optical axis direction and being positioned at a desired position in the optical axis direction with respect to the objective optical system is provided at the end of the objective optical system, by pressing the surface of the examination site of the sample with the end of the abutting member, the influence of pulsation or the like of the sample on the surface of the examination site can be reduced (or eliminated) Moreover, since the distance between the surface of the examination site and the end of the objective optical system (that is, the working distance) can be kept constant at all times, a shift of the working distance can be prevented, thereby obtaining a clear image

### BRIEF DESCRIPTION OF THE SEVERAL VIEWS OF THE DRAWINGS

FIG. 1 is a diagram according to a first embodiment of the present invention, being an enlarged view of the main part in which a part enclosed by a circle C in FIG. 13 is enlarged.

FIGS. 2A and 2B are diagrams according to a second embodiment of the present invention, 2A being an enlarged front elevation of the main part, and 2B being a cross section in the direction of arrow II-II in FIG. 2A.

FIG. 3 is a diagram according to a third embodiment of the present invention, being similar to FIG. 1.

FIG. 4 is a diagram according to a fourth embodiment of the present invention, being similar to FIG. 1.

FIG. 5 is a diagram according to a fifth embodiment of the present invention, being similar to FIG. 1.

FIG. 6 is a diagram according to a sixth embodiment of the present invention, being similar to FIG. 1.

FIG. 7 is a diagram according to a seventh embodiment of the present invention, being similar to FIG. 1.

FIG. 8 is a diagram according to an eighth embodiment of the present invention, being similar to FIG. 1.

FIG. 9 is a diagram according to a ninth embodiment of the present invention, being similar to FIG. 1.

FIG. 10 is a diagram according to a tenth embodiment of the present invention, being similar to FIG. 1.

FIG. 11 is a diagram according to an eleventh embodiment of the present invention, being similar to FIG. 1.

FIG. 12 is a diagram according to a twelfth embodiment of the present invention, being similar to FIG. 1.

FIG. 13 is a schematic block diagram of a laser scanning-type confocal microscope according to the first embodiment of the present invention.

### DETAILED DESCRIPTION OF THE INVENTION

The laser scanning-type confocal microscope according to a first embodiment of the present invention will be described with reference to the accompanying drawings.

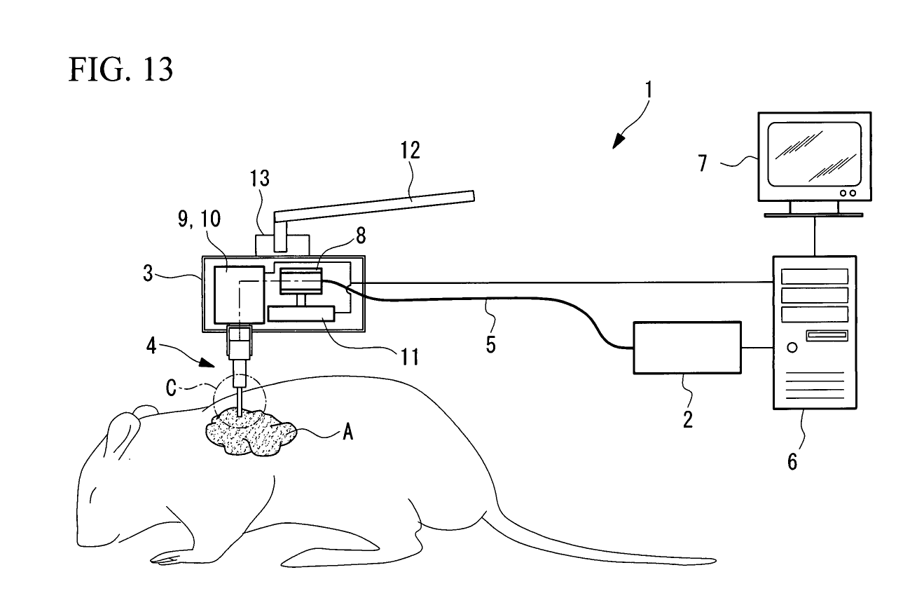

A laser scanning-type confocal microscope 1 according to the first embodiment includes, as shown in FIG. 13, an optical unit 2, a scanning unit 3, an objective optical system unit (objective optical system) 4 fitted to the scanning unit 3, an optical fiber 5 connecting the optical unit 2 and the scanning unit 3, a processing controller 6 such as a personal computer, and a display 7 for displaying an image, as main components.

The optical unit 2 includes a laser light source unit and a detection optical system.

The laser light source unit includes a laser light source formed of a semiconductor laser, a collimate optical system formed of a lens and a pinhole, and a dichroic mirror.

The detection optical system includes a dichroic mirror, a barrier filter, a lens, a confocal pinhole, and a light-receiving sensor.

The optical unit 2 is provided with a dichroic mirror for leading excitation light from the laser light source unit to a sample A (for example, an organ or the like of a rat, a small animal or the like) and guiding fluorescence from the sample A to the light-receiving sensor.

The scanning unit 3 includes a collimate optical system 8 that substantially collimates the excitation light from the optical fiber 5, an optical scanner 9 that scans the excitation light from the collimate optical system 8 on the sample A, and a pupil projection optical system 10 that images the excitation light from the optical scanning unit 9 at a position of an intermediate image.

The collimate optical system 8 includes a position adjustment mechanism 11 capable for shifting the collimate lens constituting the collimate optical system 8 in the optical axis direction.

The optical scanning unit 9 includes two galvano mirrors swingable about axes orthogonal to each other, which can two-dimensionally scan the parallel beams emitted from the collimate optical system 8.

The objective optical system unit 4 is constructed so that the intermediate image of the excitation light imaged in the pupil projection optical system 10 is re-imaged on the sample A, and the focal position becomes conjugate near the central positions of the two galvano mirrors constituting the optical scanner 9 by means of the pupil projection optical system 10.

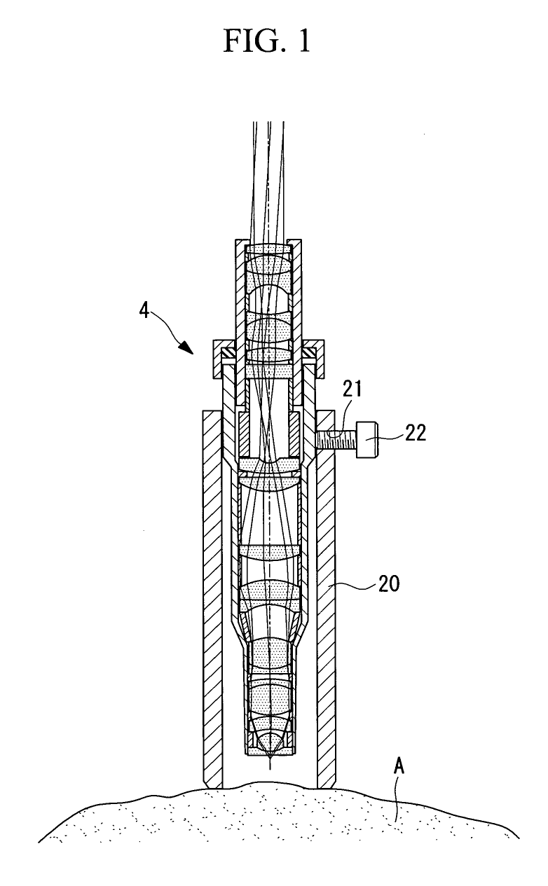

As shown in FIG. 1 in which a part enclosed by circle C in FIG. 13 is shown in an enlarged scale, an abutting member 20 is fitted to the end of the objective optical system unit 4. The abutting member 20 is a hollow cylindrical member, the inner diameter of which is formed so as to be substantially equal to the outer diameter in the substantial central part of the objective optical system unit 4, and the abutting member 20 is capable of moving in the axial direction (vertical direction in the figure) with respect to the objective optical system unit 4.

At the upper end of the abutting member 20 (that is, at a position opposite to the substantial central part of the objective optical system unit 4), a screw hole 21 is provided, and a screw 22 which is threaded together with the screw hole 21 is inserted into the screw hole 21. The abutting member 20 is fixed with respect to the objective optical system unit 4, by abutting the tip of the screw 22 against the outer surface of the objective optical system unit 4.

The optical fiber 5 transmits the excitation light emitted from the laser light source unit, and on the other hand, guides the fluorescence emitted from the sample A to the detection optical system.

As a result, the fluorescence emitted from the sample A is detected by the light-receiving sensor in the detection optical system housed in the optical unit 2, after having passed through the objective optical system unit 4, the pupil projection optical system 10, the optical scanner 9, the collimate optical system 8, and the optical fiber 5.

To the laser scanning-type confocal microscope 1 is connected the processing controller 6 such as a personal computer. The processing controller 6 performs wavelength control of the laser light source, wavelength selection of the dichroic mirror, the filter and the like, control of a wavelength separation element, analysis and display of detection information received by the light-receiving sensor in the detection optical system, and drive control of the optical scanner 9.

To the processing controller 6 is connected the display 7, so that an image obtained by the laser scanning-type confocal microscope 1 is displayed on a screen.

The operation of the laser scanning-type confocal microscope 1 according to the first embodiment constructed in this manner will be described below.

According to the laser scanning-type confocal microscope 1 in the first embodiment, the excitation light emitted from the laser light source is focused to the pinhole by the lens, and converted to parallel light by the lens. Thereafter, the excitation light is focused to the end face of the optical fiber 5 through the dichroic mirror and a condenser lens, transmitted through the optical fiber, and guided to the scanning unit 3. In the scanning unit 3, the light emitted from the end face of the optical fiber 5 is guided to the optical scanner 9, with the light being converted to parallel light by the collimate optical system 8, and the beam of light is shifted two-dimensionally with respect to the optical axis, with the rotation of the respective galvano mirrors in the optical scanner 9. Then, the excitation light passes through the pupil projection optical system 10 and is focused to the position of the intermediate image and imaged. The excitation light focused to the position of the intermediate image is irradiated to the sample A in minute spots through the objective optical system unit 4. At this time, the excitation light irradiated onto the sample A is scanned by the optical scanner 9.

The fluorescence excited by the sample A due to the irradiation of the excitation light passes through the objective optical system unit 4, the pupil projection optical system 10, the optical scanner 9, the collimate optical system 8, the optical fiber 5, the condenser lens, and the dichroic mirror, and is guided to the detection optical system. In the detection optical system, only the fluorescence having passed through the dichroic mirror, the barrier filter, the lens and the pinhole is detected by the light-receiving sensor.

Thus, the abutting member 20 which can move and be positioned in the axial direction with respect to the objective optical system unit 4 is provided at the end of the objective optical system unit 4, and by pressing the surface of the examination site of the sample A with the end (lower end in FIG. 1) of the abutting member 20, the influence of pulsation or the like of the sample on the surface of the examination site can be reduced (or eliminated). As a result, a change in the distance between the surface of the examination site and the end of the objective optical system unit 4 can be prevented, and a shift of the focal position can be prevented, thereby obtaining a clear image at all times.

According to the laser scanning-type confocal microscope 1 in the first embodiment, since the intermediate image is formed between the pupil projection optical system 10 and the objective optical system unit 4 by the pupil projection optical system 10, the length of the optical system from the pupil projection optical system 10 to the end of the objective optical system unit 4 can be made sufficiently long, and the thickness thereof can be set to be sufficiently thin. As a result, the outer diameter of the objective optical system unit 4 can be reduced, so that the end of the objective optical system unit 4 can reach the examination site of the sample A located deep in the body, without largely incising an experimental small animal or the like, with low invasion and without giving a much damage to the experimental small animal or the like.

Moreover, since the optical unit 2 and the scanning unit 3 are connected by the optical fiber 5, the scanning unit 3 can be made compact. As a result, the optical fiber 5 can be flexibly curved, to change the inclination and the position of the scanning unit 3, thereby simplifying the handling.

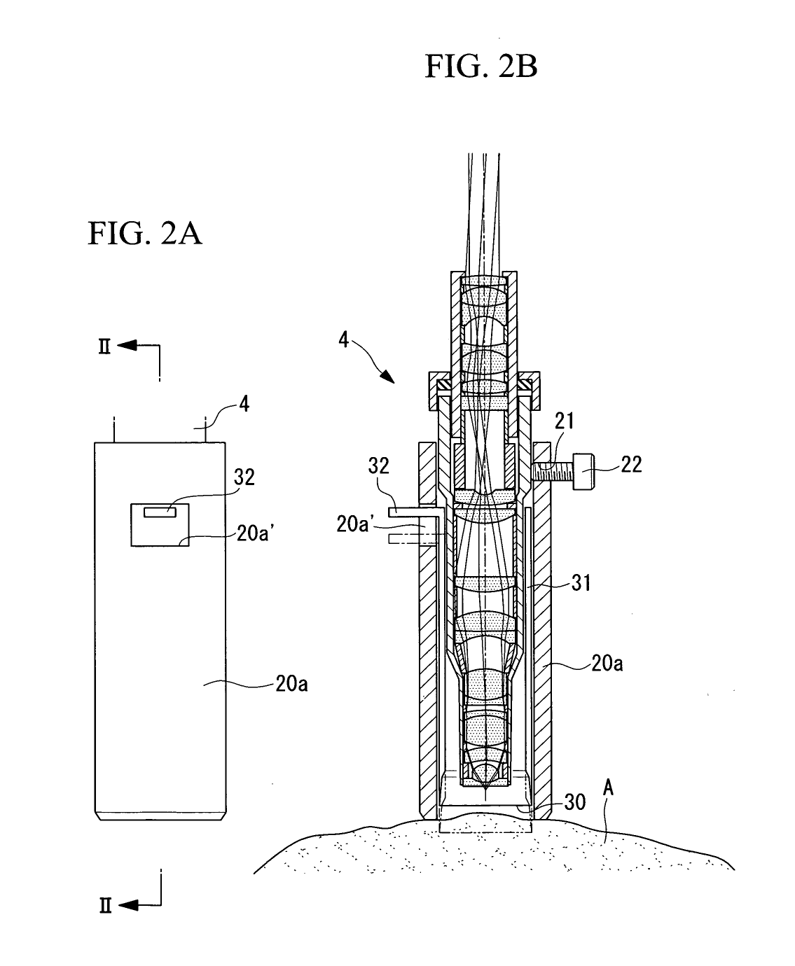

A second embodiment of the laser scanning-type confocal microscope according to the present invention will be described with reference to FIGS. 2A and 2B.

The laser scanning-type confocal microscope in the second embodiment is different from that of the first embodiment in that a middle cylinder 31 having a circle cutter 30 formed at the end is further provided at the end of the objective optical system unit 4. The other components are the same as in the first embodiment, and hence the explanation thereof is omitted.

Like reference symbols refer to like parts in the first embodiment.

The middle cylinder 31 is a hollow cylindrical member formed so as to be positioned between the objective optical system unit 4 and the abutting member 20a, and be able to move with respect to both the objective optical system unit 4 and the abutting member 20a.

The circle cutter 30 provided at the end of the middle cylinder 31 has a blade formed around the whole circumferential direction, which can cut out the membrane on the surface of the sample A in a round shape, when being pressed against the surface of the sample A and rotated slightly.

At the upper part of the middle cylinder 31 (at the end on the opposite side to where the circle cutter 30 is provided), a cutter operating knob 32 is provided, and an operator (examiner) operates the cutter operating knob 32 to cut out the membrane on the surface of the sample A in a round shape.

On the other hand, an opening 20a′ through which the cutter operating knob 32 penetrates is provided on the abutting member 20a, so that the middle cylinder 31 can be operated from the outside of the abutting member 20a.

As shown in FIG. 2A, the opening 20a′ is a through hole in a rectangular shape as seen from the front, and when the cutter operating knob 32 abuts against the upper end of the opening 20a′ (in FIG. 2B, when the cutter operating knob 32 is at a position indicated by the solid line), the whole circle cutter 30 is housed completely in the abutting member 20a, and when the cutter operating knob 32 abuts against the lower end of the opening 20a′ (in FIG. 2B, when the cutter operating knob 32 is at a position indicated by the two-dot chain line), the circle cutter 30 protrudes from the lower end of the abutting member 20a by a predetermined length. Moreover, by moving the cutter operating knob 32 horizontally in the state with the cutter operating knob 32 abutting against the lower end of the opening 20a′, to rotate the circle cutter 30, the membrane on the surface of the sample A can be cut out.

Thus, by including the middle cylinder 31 having the circle cutter 30 formed at the end thereof, the membrane on the surface of the sample A is cut out in a round shape, so that the tissue under the surface can be easily examined. At this time, when the circle cutter 30 is moved, it is not necessary to move the outside abutting member 20a. Hence, particularly when it is inserted to a deep tissue, the sample can be cut out by the cutter, without damaging the surrounding tissue. Therefore, the tissue located deep under the surface can be examined by using the inexpensive laser scanning-type confocal microscope having a simple structure, without using an expensive multiphoton excitation type microscope having a complicated structure, at a level as good as the multiphoton excitation type microscope.

Other operation and effects are the same as those in the first embodiment, and hence, the explanation thereof is omitted.

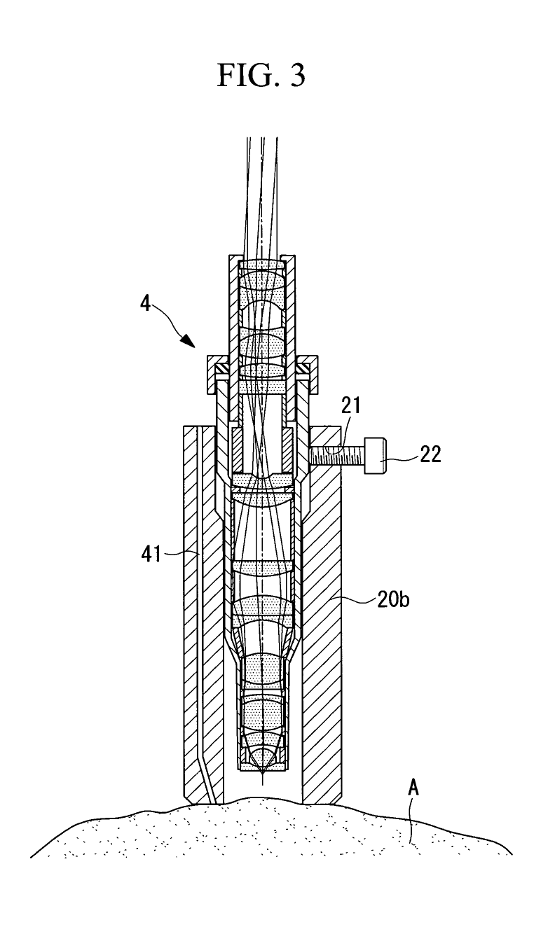

A third embodiment of the laser scanning-type confocal microscope according to the present invention will be described with reference to FIG. 3.

The laser scanning-type confocal microscope in this embodiment is different from the one in the first embodiment in that an abutting member 20b having a service port 41 formed therein is provided at the end of the objective optical system unit 4. The other components are the same as in the embodiments described above, and hence the explanation thereof is omitted.

Like reference symbols refer to like parts in the first embodiment.

The service port 41 is a communicating hole connecting the upper end and the lower end of the abutting member 20b, and by connecting a suction tube to the upper end side, the internal secretion and the like on the surface of the sample A can be sucked. Moreover, air and physiological saline solution can be supplied onto the surface of the sample A by connecting an air supply tube or a physiological saline solution supply tube to the upper end thereof.

Since such a service port 41 is provided so that the internal secretion on the surface of the sample A can be sucked and removed or washed by the physiological saline solution, the observation field of view can be kept clean at all times, thereby enabling favorable examination.

Other operation and effects are the same as those in the first embodiment, and hence, the explanation thereof is omitted.

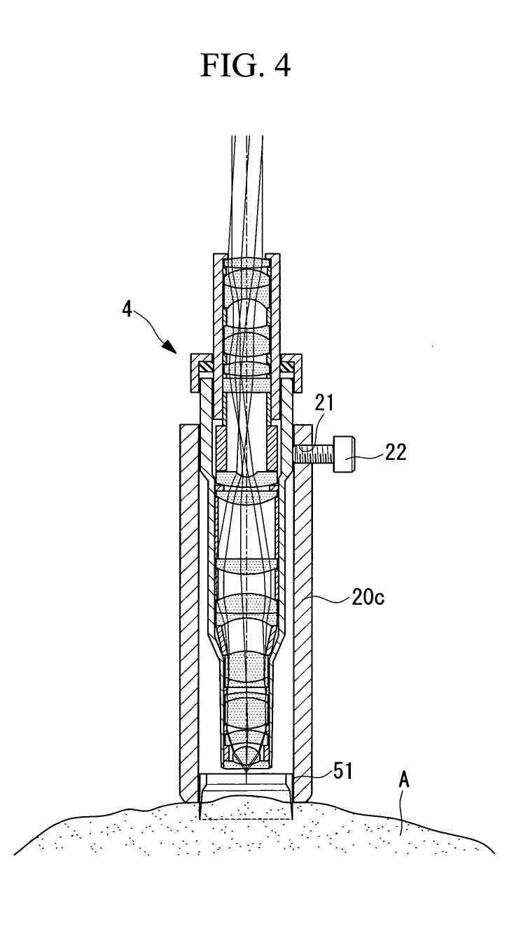

A fourth embodiment of the laser scanning-type confocal microscope according to the present invention will be described with reference to FIG. 4.

The laser scanning-type confocal microscope in this embodiment is different from the one in the first embodiment in that a circle cutter 51 formed at the end of an abutting member 20c is further provided at the end of the objective optical system unit 4. The other components are the same as in the embodiments described above, and hence the explanation thereof is omitted.

Like reference symbols refer to like parts in the first embodiment.

The circle cutter 51 is similar to the circle cutter 30 (see FIGS. 2A and 2B) explained in the second embodiment, and is fixed at the end of the abutting member 20c in this embodiment, whereas in the second embodiment, the circle cutter 30 is formed at the end of the middle cylinder 31.

Thus, by fitting the circle cutter 51 at the end of the abutting member 20c, the membrane on the surface of the sample A can be cut out in a round shape by only pressing the end face of the abutting member 20c against the surface of the sample A and rotating the abutting member 20c, thereby enabling easy examination of the tissue under the surface. Therefore, the tissue located deep under the surface can be examined by using an inexpensive laser scanning-type confocal microscope having a simple structure, without using an expensive multiphoton excitation type microscope having a complicated structure, at a level as good as the multiphoton excitation type microscope.

Moreover, when the end face of the abutting member 20c abuts against the surface of the sample A, the circle cutter 51 cannot advance toward the sample A anymore. That is, since the end face of the abutting member 20c plays a role of a so-called stopper, the surface of the sample A can be cut out by a desired depth at all times.

Furthermore, it is not necessary to provide the middle cylinder 31 as in the second embodiment, and the separately prepared circle cutter 51 needs only to be fitted to the end of the abutting member 20c. As a result, the configuration can be simplified, and the production cost can be reduced.

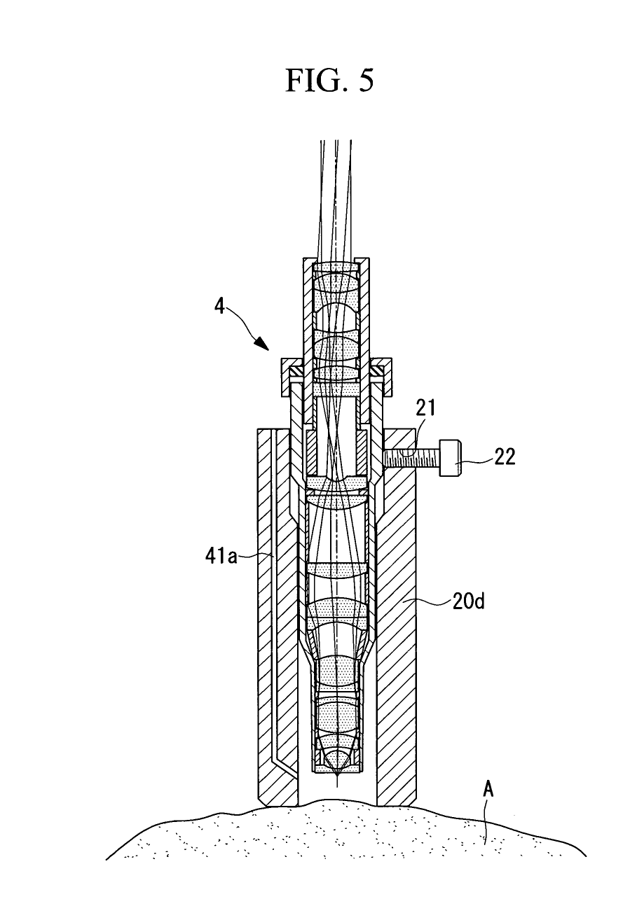

A fifth embodiment of the laser scanning-type confocal microscope according to the present invention will be described with reference to FIG. 5.

The laser scanning-type confocal microscope in this embodiment is different from the one in the first embodiment in that an abutting member 20d having a service port 41a formed therein is provided at the end of the objective optical system unit 4. The other components are the same as in the embodiments described above, and hence the explanation thereof is omitted.

Like reference symbols refer to like parts in the first embodiment.

The service port 41a is a communicating hole connecting the upper end and the inner face at the lower end of the abutting member 20d, and by connecting a suction tube to the upper end side, the internal secretion and the like on the surface of the sample A can be sucked. Moreover, air and physiological saline solution (refractive index: 1.35) or a silicone oil (refractive index: 1.5) can be supplied onto the surface of the sample A by connecting an air supply tube and a physiological saline solution supply tube or a silicon oil supply tube to the upper end thereof.

Since such a service port 41a is provided so that the internal secretion on the surface of the sample A can be sucked and removed or washed by the physiological saline solution, the observation field of view can be kept clean at all times, thereby enabling favorable examination.

Moreover, by sucking the inside of the abutting member 20d to hold the abutting member 20d and the sample in an attracted state, more stable examination becomes possible.

Furthermore, the objective optical system unit 4 is designed so that a fluid (physiological saline solution or silicon oil) having a refractive index higher than that of air (refractive index: 1.0) can be filled in the space surrounded by the outer face at the end of the objective optical system unit 4, the inner face of the abutting member 20d, and the surface of the sample A. Therefore, the resolution ((resolution)=0.61λ/NA, NA=n (refractive index) Sin) is improved, and by increasing a light-gathering rate (since an angle for fetching the light is increased, fluorescence emitting light in all directions can be fetched in a larger amount), the detection sensitivity can be increased, the speed for obtaining an image can be increased, and the amount of irradiated light can be decreased to reduce damage to the cells.

Other operation and effects are the same as those in the first embodiment, and hence, the explanation thereof is omitted.

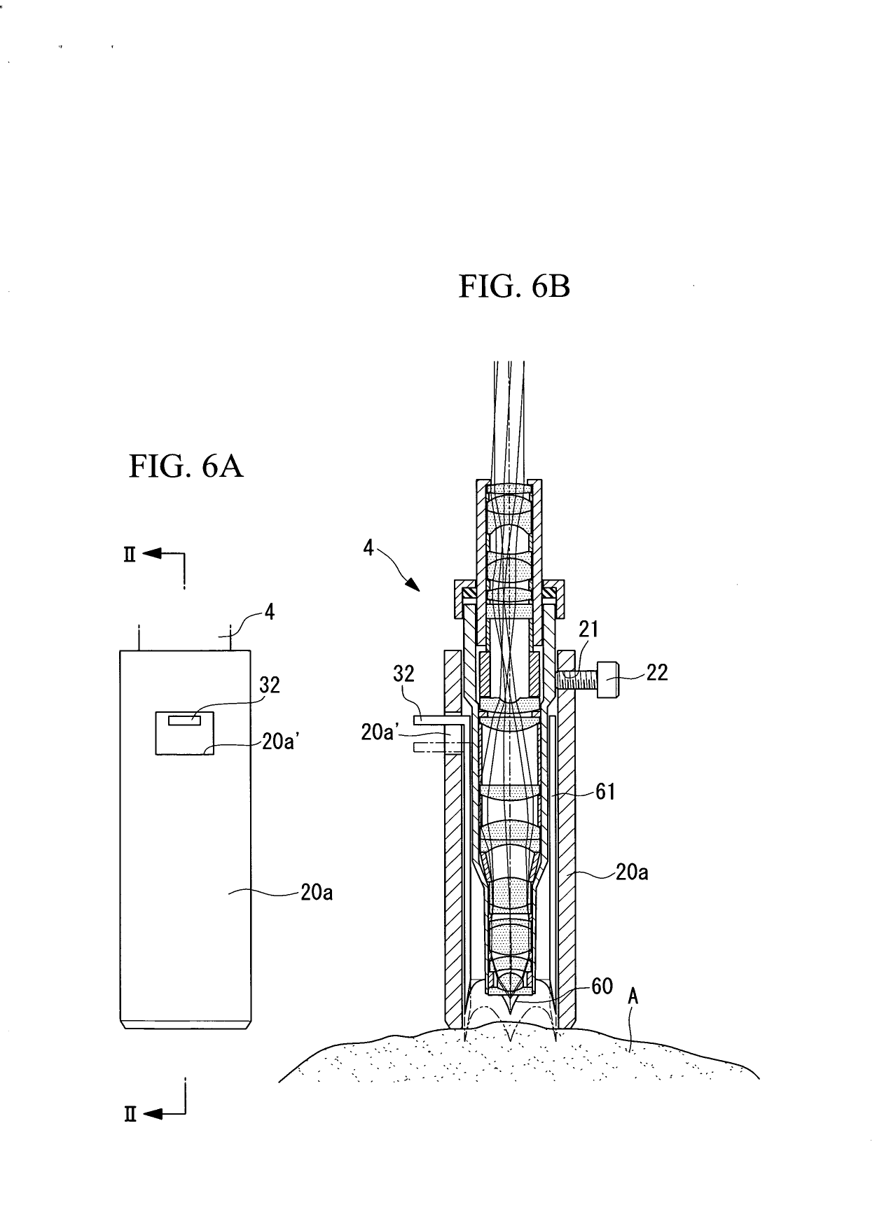

A sixth embodiment of the laser scanning-type confocal microscope according to the present invention will be described with reference to FIG. 6.

The laser scanning-type confocal microscope in this embodiment is different from the one in the second embodiment in that a middle cylinder 61 having a circle cutter 60 having a plurality of blades (in this embodiment, four) partially formed thereon is provided at the end of the objective optical system unit 4. The other components are the same as in the second embodiment, and hence the explanation thereof is omitted.

Like reference symbols refer to like parts in the second embodiment.

The middle cylinder 61 is a hollow cylindrical member formed so as to be positioned between the objective optical system unit 4 and the abutting member 20a, and be able to move with respect to both the objective optical system unit 4 and the abutting member 20a.

The circle cutter 60 provided at the end of the middle cylinder 61 has four blades formed at an interval of 90 degrees, and when being pressed against the surface of the sample A and rotated about 90 degrees, the circle cutter 61 can cut out the membrane on the surface of the sample A in a round shape.

At the upper part of the middle cylinder 61 (at the end on the opposite side to where the circle cutter 60 is provided), a cutter operating knob 32 is provided as in the second embodiment, and an operator (examiner) operates the cutter operating knob 32 to cut out the membrane on the surface of the sample A in a round shape.

Moreover, each blade is formed, as shown in FIG. 6B, in a pointed shape at the end, and since the cutter operating knob 32 is moved straight downward (toward the sample A), the point of each blade is stabbed into the sample A, so that the middle cylinder 61 is not easily rotated.

Thus, by forming the ends of respective blades of the circle cutter 60 in a pointed shape, these pointed portions can be stabbed into the surface of the sample A, thereby holding the relative position of the objective optical system unit 4 and the sample A.

Other operation and effects are the same as those in the first embodiment, and hence, the explanation thereof is omitted.

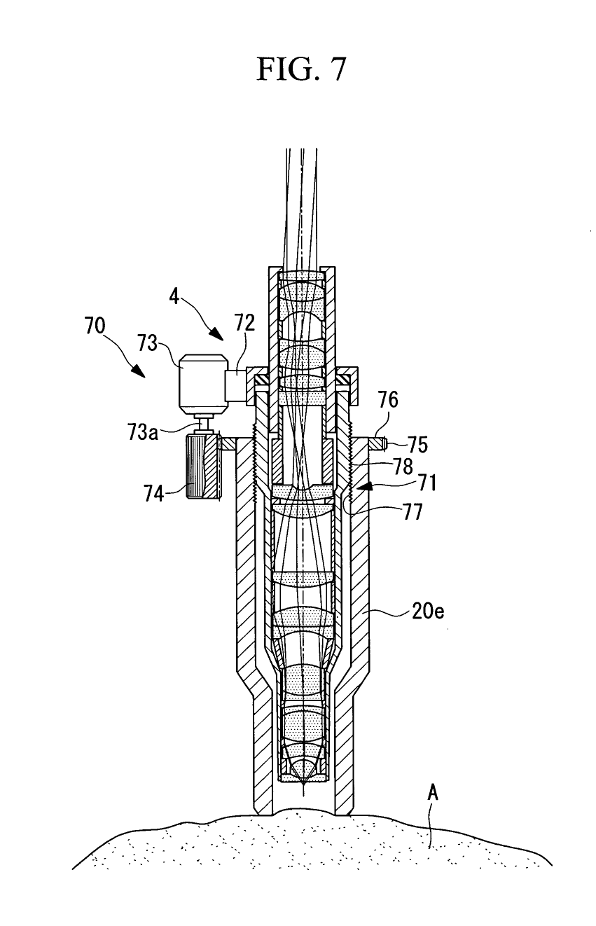

A seventh embodiment of the laser scanning-type confocal microscope according to the present invention will be described with reference to FIG. 7.

The laser scanning-type confocal microscope in this embodiment is different from the one in the first embodiment in that a driving unit 70 and a screw unit 71 are provided instead of the screw hole 21 and the screw 22 in the first embodiment. The other components are the same as in the embodiments described above, and hence the explanation thereof is omitted.

Like reference symbols refer to like parts in the first embodiment.

The driving unit 70 includes a motor 73 fitted to the upper part of the objective optical system unit 4 via a support 72, a gear 74 fitted to a rotation shaft 73a of the motor 73, and teeth 75 engaging with the gear teeth of the gear 74, and further includes a flange 76 provided at the upper part of the objective optical system unit 4 positioned lower than the support 72, as main components.

The screw unit 71 includes a female screw 77 formed on the upper inner wall of the abutting member 20e, and a male screw 78 formed on the upper outer wall of the objective optical system unit 4 so as to engage with the female screw 77.

When the rotation shaft 73a of the motor 73 is rotated positively or reversely, the abutting member 20e is rotated positively or reversely with respect to the objective optical system unit 4 via the gear 74 and the teeth 75, thereby adjusting the distance between the surface of the sample A and the end of the objective optical system unit 4.

Also by employing such a driving unit 70 and screw unit 71, a similar operation and effect to those of the first embodiment can be obtained.

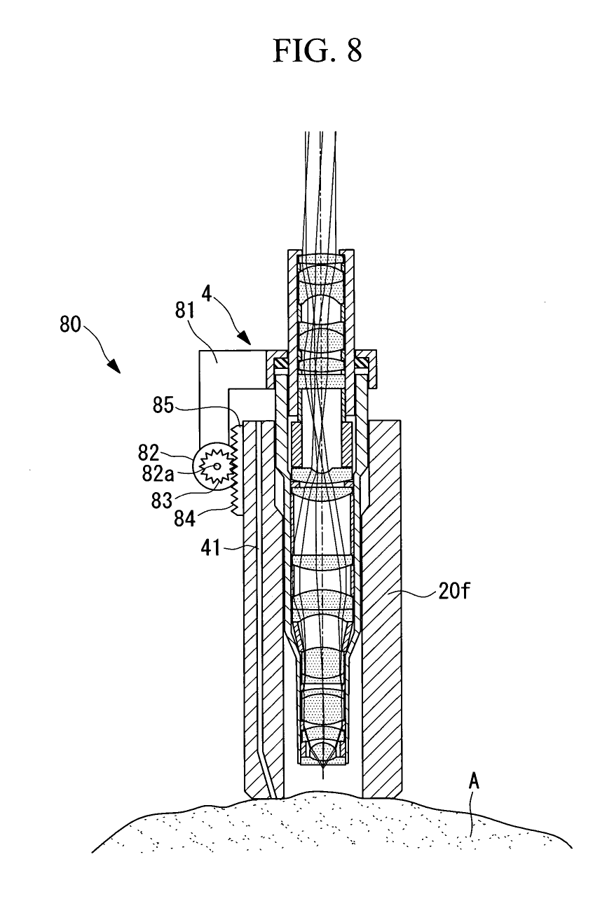

An eighth embodiment of the laser scanning-type confocal microscope according to the present invention will be described with reference to FIG. 8.

The laser scanning-type confocal microscope in this embodiment is different from the one in the first embodiment in that a driving unit 80 is provided instead of the screw hole 21 and the screw 22 in the first embodiment, and an abutting member similar to the abutting member 20b explained in the third embodiment is employed as an abutting member 20f. The other components are the same as in the first and the third embodiments described above, and hence the explanation thereof is omitted.

Like reference symbols refer to like parts in the first and the third embodiments.

The driving unit 80 includes a motor 82 fitted to the upper part of the objective optical system unit 4 via a support 81, a pinion 83 fitted to a rotation shaft 82a of the motor 82, and a rack 85 having teeth 84 engaging with the teeth of the pinion 83, as main components.

When the rotation shaft 82a of the motor 82 is rotated positively or reversely, the abutting member 20f is moved downward or upward with respect to the objective optical system unit 4 via the pinion 83 and the rack 84, thereby adjusting the distance between the surface of the sample A and the end of the objective optical system unit 4.

Also by employing such a driving unit 80 and screw unit 71, a similar operation and effect to those of the first and the third embodiments can be obtained.

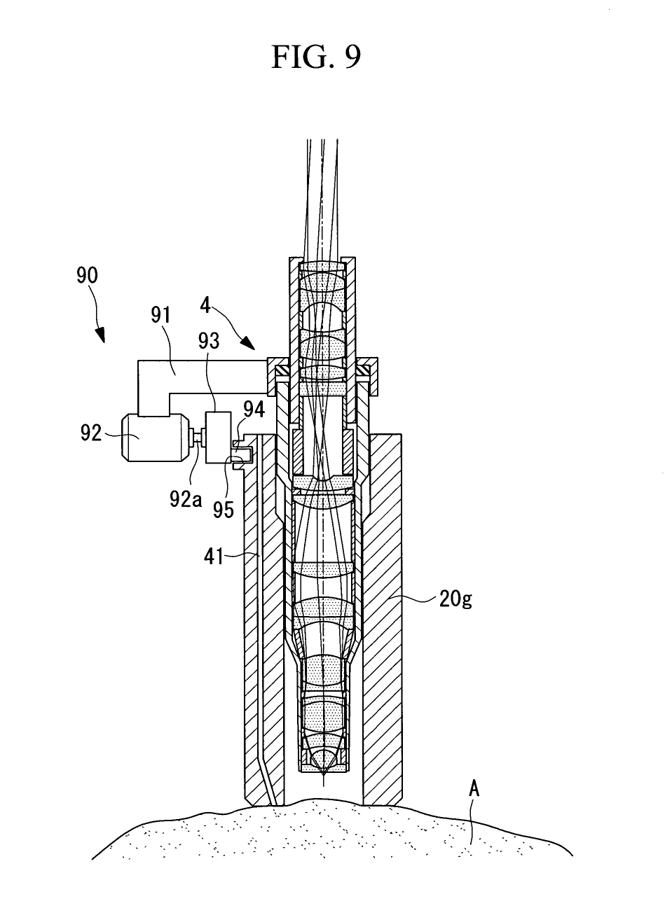

A ninth embodiment of the laser scanning-type confocal microscope according to the present invention will be described with reference to FIG. 9.

The laser scanning-type confocal microscope in this embodiment is different from the one in the eighth embodiment in that a driving unit 90 is provided instead of the driving unit 80 in the eighth embodiment. The other components are the same as in the eighth embodiment described above, and hence the explanation thereof is omitted.

Like reference symbols refer to like parts in the eighth embodiment.

The driving unit 90 includes a motor 92 fitted to the upper part of the objective optical system unit 4 via a support 91, a disc 93 fitted to a rotation shaft 92a of the motor 92, a pin 94 provided at a rim portion of the disc 93, and a recess 95 formed at the upper end of an abutting member 20g for receiving the pin 94, as main components.

When the rotation shaft 92a of the motor 92 is rotated positively or reversely, the abutting member 20g is moved downward or upward with respect to the objective optical system unit 4 via the pin 94 and the recess 95, thereby adjusting the distance between the surface of the sample A and the end of the objective optical system unit 4.

Also by employing such a driving unit 90, a similar operation and effect to those of the eighth embodiment can be obtained.

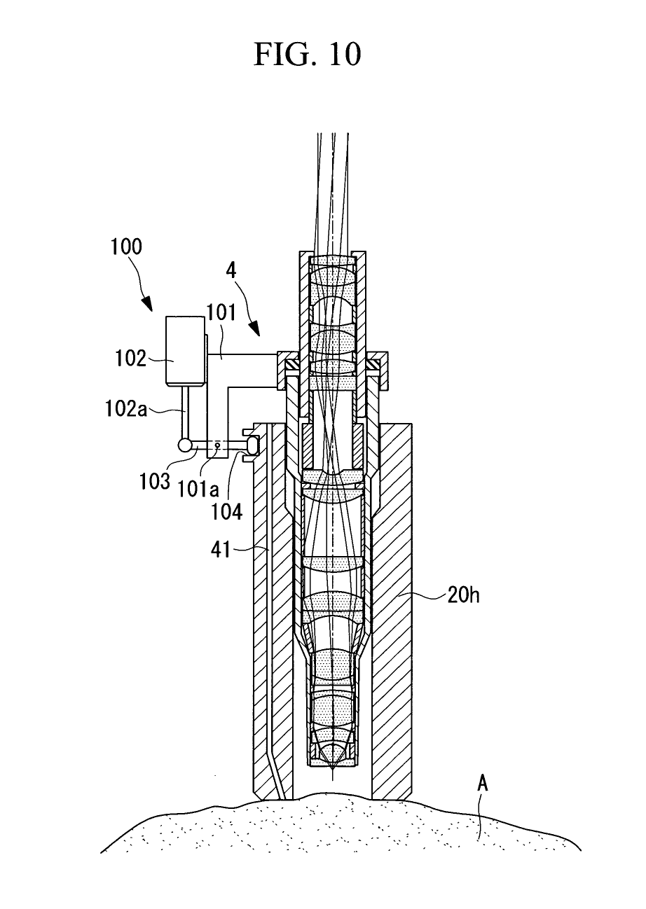

A tenth embodiment of the laser scanning-type confocal microscope according to the present invention will be described with reference to FIG. 10.

The laser scanning-type confocal microscope in this embodiment is different from the one in the eighth embodiment in that a driving unit 100 is provided instead of the driving unit 80 in the eighth embodiment. The other components are the same as in the eighth embodiment described above, and hence the explanation thereof is omitted.

Like reference symbols refer to like parts in the eighth embodiment.

The driving unit 100 includes an actuator 102 fitted to the upper part of the objective optical system unit 4 via an L-shape support 101, a lever 103 with the one end thereof fitted to a rod 102a of the actuator 102 and the central part thereof fitted to the lower end of the support 101 via a hinge 101a, and a recess 104 formed at the upper end of an abutting member 20h for receiving the other end of the lever 103, as main components.

When the rod 102a of the actuator 102 is advanced or retreated, the abutting member 20h is moved upward or downward with respect to the objective optical system unit 4 via the lever 103 and the recess 104, thereby adjusting the distance between the surface of the sample A and the end of the objective optical system unit 4.

Also by employing such a driving unit 100, a similar operation and effect to those of the eighth embodiment can be obtained.

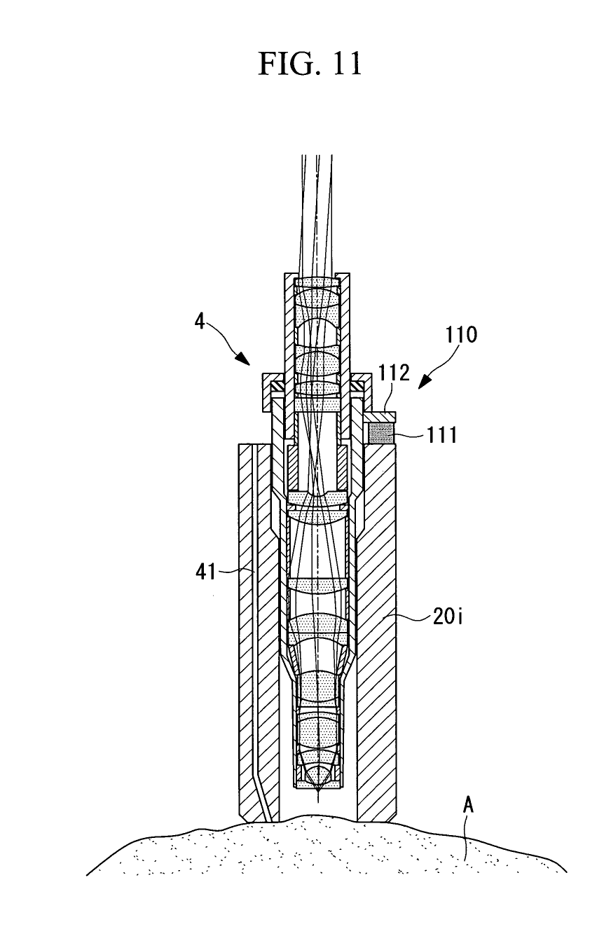

An eleventh embodiment of the laser scanning-type confocal microscope according to the present invention will be described with reference to FIG. 11.

The laser scanning-type confocal microscope in this embodiment is different from the one in the eighth embodiment in that a driving unit 110 is provided instead of the driving unit 80 in the eighth embodiment. The other components are the same as in the eighth embodiment described above, and hence the explanation thereof is omitted.

Like reference symbols refer to like parts in the eighth embodiment.

The driving unit 110 comprises a piezoelectric element 111, which converts an electric signal to a mechanical vibration energy. The upper face of the piezoelectric element 111 is fitted (bonded) to the lower face of a support 112 provided at the upper part of the objective optical system unit 4, and the lower face thereof is fitted (bonded) to the upper face of an abutting member 20i.

The piezoelectric element 111 changes the size (thickness) when an alternating current is supplied, thereby adjusting the distance between the surface of the sample A and the end of the objective optical system unit 4.

Also by employing such a driving unit 110, a similar operation and effect to those of the eighth embodiment can be obtained.

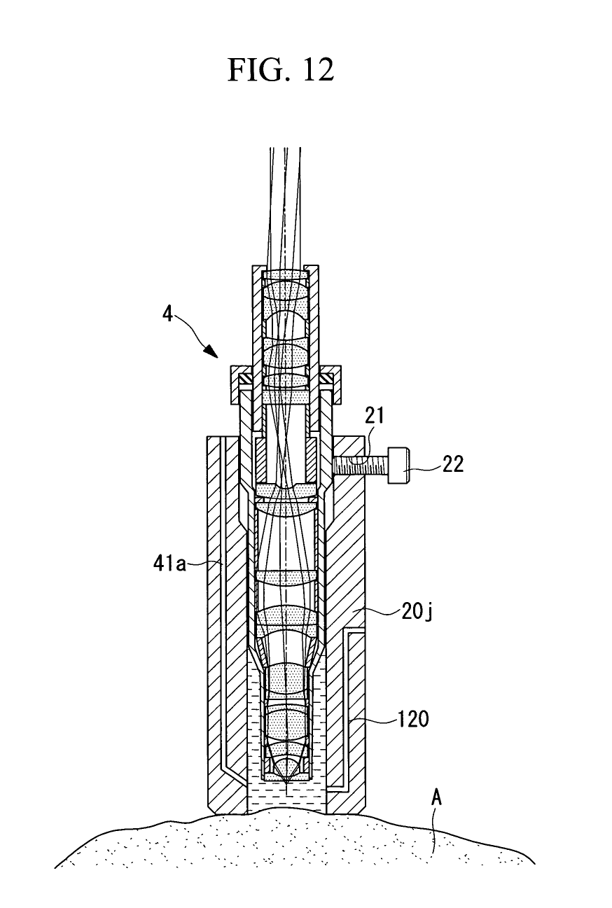

A twelfth eleventh embodiment of the laser scanning-type confocal microscope according to the present invention will be described with reference to FIG. 12.

The laser scanning-type confocal microscope in this embodiment is different from the one in the fifth embodiment in that an abutting member 20j having a service port 41a and a second service port 120 is provided instead of the abutting member 20d in the fifth embodiment. The other components are the same as in the fifth embodiment described above, and hence the explanation thereof is omitted.

Like reference symbols refer to like parts in the eighth embodiment.

The second service port 120 is a communicating hole connecting the inner face at the lower end and the outer face at the central part of the abutting member 20j, and by connecting a discharge tube to the outer face at the central part, fluid such as internal secretion, blood, physiological saline solution or silicon oil accumulated in the space formed by the surface of the sample A, the inner face of the abutting member 20j and the outer face of the objective optical system unit 4 can be discharged out of the space. As a result, particularly the influence of blood can be eliminated.

Moreover, delicate focus control can be realized by controlling the amount (pressure) of the physiological saline solution or the silicon oil supplied to the space via the service port 41a, and the amount (pressure) of the physiological saline solution or the silicon oil discharged out of the space through the second service port 120. Since the objective optical system unit 4 and the abutting member 20j are hard, the sample A is soft, and the compressibility of the physiological saline solution and the silicon oil is low, the sample A may be attracted or depressed. As a result, the distance between the objective optical system unit 4 and the sample A changes delicately, thereby enabling a control of a minute amount with a sufficient stroke as a microscopic distance.

When the deep part of the sample is to be examined, the physiological saline solution is preferable. The refractive index of the physiological saline solution is close to an average refractive index of the biological tissue, and hence, the physiological saline solution is preferred for maintaining the performance of the objective optical system unit 4. This is because it is better to keep the refractive index between the objective optical system unit 4 and the surface to be examined constant, since the space surrounded by the outer face of the end of the objective optical system unit 4, the inner face of the abutting member 20j, and the surface of the sample A also serves as a lens.

The present invention is applicable not only to the laser scanning-type confocal microscope, but also to other types of microscopes.

The present invention is not limited to the above described embodiments, and for example, the second embodiment and the third embodiment may be combined.

In other words, the service port 41 may be provided in the abutting member 20a, and the middle cylinder 31 having the circle cutter 30 may be provided in the abutting member 20a.

As a result, blood or the like from the sample A cut out by the circle cutter 30 can be removed via the service port 41, thereby keeping the observation field of view clean at all times, and enabling favorable examination.

Moreover, an injection needle may be provided in the service port 41 so as to be able to advance or retreat.

As a result, a medical fluid or colorant can be injected into the examination site.

Furthermore, it is not always necessary that the circle cutter 30 or 51 is provided over the whole circumference, and only one partially formed blade may be provided, or two or more partially formed blades may be provided.

1. A microscope comprising an abutting member at an end of an objective optical system to be arranged close to a sample, which is capable of moving in an optical axis direction and being positioned at a desired position in the optical axis direction with respect to the objective optical system.

2. A microscope according to claim 1, wherein the abutting member comprises a cylindrical member arranged outside of an outer cylinder of the objective optical system.

3. A microscope according to claim 1, wherein a cutter having a blade provided so as to be able to move in an optical axis direction with respect to an outer cylinder of the objective optical system unit and the abutting member, and to protrude from the end of the abutting member, is provided between the outer cylinder of the objective optical system and the abutting member.

4. A microscope according to claim 3, wherein the cutter is provided rotatably about the optical axis of the objective optical system.

5. A microscope according to claim 1, wherein the abutting member is provided with a service port, through which a fluid can be injected to the vicinity of the end of the objective optical system, or the fluid can be sucked from the vicinity of the end of the objective optical system.

6. A microscope according to claim 1, wherein a cutter is provided at the end of the abutting member.
